(19) United States
(12) Patent Application Publication
(10) Pub. No.: US 2013/0260801 A1
(43) Pub. Date: Oct. 3, 2013

(54) APPARATUS AND METHOD FOR TRANSCEIVING MULTICAST TRAFFIC IN A WIRELESS ACCESS SYSTEM SUPPORTING MACHINE-TO-MACHINE COMMUNICATION

(71) Applicants: Jeongki Kim, Anyang-Si (KR); Giwon Park, Anyang-Si (KR); Youngsoo Yuk, Anyang-Si (KR)

(72) Inventors: Jeongki Kim, Anyang-Si (KR); Giwon Park, Anyang-Si (KR); Youngsoo Yuk, Anyang-Si (KR)

(73) Assignee: LG ELECTRONICS INC., Seoul (KR)

(21) Appl. No.: 13/990,706

(22) PCT Filed: Dec. 2, 2011
(86) PCT No.: PCT/KR2011/009332

§ 371 Date: May 30, 2013

Related U.S. Application Data
(60) Provisional application No. 61/419,718, filed on Dec. 3, 2010.
(60) Provisional application No. 61/422,221, filed on Dec. 13, 2010.
(60) Provisional application No. 61/440,348, filed on Feb. 7, 2011.

(30) Foreign Application Priority Data
Nov. 1, 2011 (KR) 1020110112926

(51) Int. Cl. H04W 68/02

(52) U.S. Cl. CPC H04W 68/02
USPC 455/458

(57) ABSTRACT

Disclosed is a method for receiving multicast traffic by a mobile station in an idle mode in a wireless access system supporting machine-to-machine (M2M) communication. The method comprises: receiving a paging message including control information indicating a multicast traffic reception during a paging listening interval from a base station (BS); and receiving multicast traffic from the BS without idle mode termination based on the received control information, wherein the paging message further includes identification information indicating an M2M group to which the multicast traffic is transmitted.

### TECHNICAL FIELD

The present invention relates to a wireless access system supporting M2M communication (or machine type communication (MTC)) and, more particularly, to a method for transmitting and receiving multicast traffic and an apparatus thereof.

### BACKGROUND ART

### M2M Communication (or Machine Type Communication (MTC))

Hereinafter, M2M communication (or Machine Type communication (MTC)) will be described briefly.

M2M communication refers to communication between electronic devices as it puts it. Namely, M2M communication refers to communication between objects. In general, M2M communication refers to wired or wireless communication between electronic devices or between human-controlled devices and machines, but here, it is used to particularly designate wireless communication between electronic devices, namely, between machines or equipment. Also, M2M terminals (or M2M mobile stations) used in a cellular network have inferior performance or capabilities to those of general mobile stations.

There are numerous mobile stations within a cell, and they may be classified according to types, classes, service types, and the like, thereof.

For example, mobile stations may be divided into a human type communication (HTC) and a machine type communication (MTC) according to operation types of mobile stations. The MTC may include communication between M2M mobile stations. Here, HTC refers to transmission and reception signals upon being determined by a human being, and the MTC refers to a signal transmission by each mobile station according to the occurrence of an event or periodically without the intervention of a human being.

Also, when the M2M communication (or MTC) is considered, the number of entire mobile stations may be sharply increased. The M2M mobile stations may have the following characteristics according to services supported by the M2M mobile stations.

1. Numerous mobile stations within a cell

2. Small amount of data

3. Low transmission frequency (which may have periodicity)

4. Limited number of data characteristics

5. Insensitive to time delay

6. Have low mobility or fixed

M2M communication may be used in various fields such as protection access or connection and surveillance, tracking and discovery, public security (emergency, disaster), payment (vending machine, ticket machine, parking meter), healthcare, remote controlling, smart meter, and the like.

Characteristics of MTC Having Time-Controlled Traffic

The characteristics of MTC having time-controlled traffic are aimed to be used in an MTC application defined to transmit or receive data only during a defined time interval and avoid unnecessary signaling in other time intervals than the defined time interval. A network operator may allocate resources differently over traffic generation to thus allow the MTC applications to transmit or receive data or perform signaling in other time intervals than the defined time interval.

The defined connection period (e.g., 10 minutes) is previously agreed between the network operator and an MTC mobile station (subscriber), which is sufficiently long to guarantee a completion of normal communication between the MTC mobile station and an MTC server.

When communication with the MTC server is finished, the MTC mobile station does not need to wait until when the connection period expires, to release its connection to the MTC server.

FIG. 1 is view showing an example of a predefined time interval allocated to an MTC mobile station having time-controlled traffic characteristics.

In general, an MTC user agrees with an operator on a predefined time period with respect to a group of MTC mobile stations. A time duration in which an access is allowed is called a ‘grant time interval’ 110, and a time duration in which an access is not allowed (or forbidden) is called a ‘forbidden time interval’ 120. Also, a time duration in which communication is substantially performed in the grant time interval 100 is called a ‘communication window’ 130.

A network may communicate with the MTC mobile station during the grant time interval, and may communicate with the MTC user and the MTC server during the grant time interval. The ‘grant time interval’ does not overlap with the ‘forbidden time interval’ during which an access is forbidden.

In general, 5 to 10 minutes of communication window is sufficient for each MTC mobile station. The network operator may limit the interval of the communication window. In order to avoid a network overload, signaling and data traffic in the communication window of the MTC mobile stations are distribution according to predefined time period (e.g., by randomizing a start time of each communication window).

Idle Mode

Idle mode is a mechanism in which a mobile station (MS) can periodically receive a downlink broadcast message without a registration to a particular BS although the MS is hovering about a wireless link environment in which a plurality of BSs are present over an extensive area.

In the idle mode, every normal operation, as well as handover (HO), is stopped and only downlink synchronization is adjusted to receive a paging message, a broadcast message, only in a certain interval. The paging message is a message indicating a paging action to the MS. For example, the paging action may include performing ranging, network reentry, and the like.

The idle mode may be initiated by an MS or a BS. Namely, the MS may transmit a deregistration request message (DREG-REQ) to the BS and receive a deregistration response message (DREG-RSP) in response thereto from the BS to enter an idle mode. Also, when the BS transmits a deregistration response message (DREG-RSP) or a deregistration command message (DREG-CMD), the MS may enter the idle mode.

In the idle mode, when the MS receives a paging message corresponding to the MS during the available interval (AI), the MS is changed into a connected mode through a network entry procedure with the BS to transmit and receive data.

### DISCLOSURE OF INVENTION

### Technical Problem

In M2M communication (or MTC communication), automatic updating of an application program or firmware with respect to M2M mobile stations (or MTC mobile stations) may be a major example of M2M service. Namely, in order to update an application or firmware of each M2M mobile station, a network (e.g., an M2M server or a BS) may transmit update information to the M2M mobile stations.

However, when the network transfers the update information in a unicast manner to the respective M2M mobile stations in idle mode, because each of the M2M mobile stations needs to perform a paging process and a network re-entry procedure to each network, congestion in wireless channels may occur. Also, when the network transfers the update information to each of the M2M mobile stations in a unicast manner, delay in data reception will be increased and resource would be wasted.

Thus, an object of the present invention is to provide a method for transmitting traffic corresponding to a particular service flow by M2M group unit with respect to a particular service flow (e.g., a multicast service) to an M2M mobile station in an idle mode.

### Solution to Problem

According to an aspect of the present invention, there is provided a method for receiving multicast traffic by a mobile station in an idle mode in a wireless access system supporting machine-to-machine (M2M) communication. The method includes: receiving a paging message including control information indicating a multicast traffic reception from a base station (BS) during a paging listening interval; and receiving multicast traffic from the BS without idle mode termination based on the received control information, wherein the paging message further includes identification information indicating an M2M group to which the multicast traffic is transmitted.

The method may further include: performing a network entry procedure with the BS.

The method may further include: performing, with the BS, a dynamic service addition (DSA) procedure to add a service flow with respect to the multicast traffic, wherein an M2M group ID is assigned to the added service flow with respect to the multicast traffic through the DSA procedure.

Through the DSA procedure, a flow ID (FID) and a quality of service (QoS) parameter may be further assigned.

The performing of the network entry procedure with the BS may include: performing a capability negotiation procedure with the BS, wherein an M2M group ID is assigned to a added service flow with respect to the multicast traffic through the capability negotiation procedure.

Through the capability negotiation procedure, a flow ID (FID) and a quality of service (QoS) parameter may be further assigned.

The performing of the network entry procedure with the BS may include: performing, with the BS, a registration procedure, wherein an M2M group ID with respect to a service flow with respect to the multicast traffic is assigned through the registration procedure.

The method may further include: performing, with the BS, a DSA procedure to add service flow with respect to the multicast traffic, wherein, through the DSA procedure, a flow ID (FID) and a quality of service (QoS) parameter are further assigned.

The method may further include: performing a deregistration procedure with the BS, wherein an M2M group ID with respect to a service flow with respect to the multicast traffic is assigned through the deregistration procedure.

Through the deregistration procedure, a flow ID (FID) and a quality of service (QoS) parameter may be further assigned.

The paging message may indicate a multicast traffic reception without network re-entry with the BS.

The control information may comprise an action code field.

According to another aspect of the present invention, there is provided a mobile station for receiving multicast traffic in an idle mode of a wireless access system supporting machine-to-machine (M2M) communication, including: a radio frequency (RF) unit configured to transmit and receive RF signals; and a controller connected to the RF unit, wherein the controller is configured to control the RF unit to receive a paging message including control information indicating a multicast traffic reception from a base station (BS) during a paging listening interval and to control the RF unit to receive multicast traffic from the BS without idle mode termination, and the paging message further includes identification information indicating an M2M group to which the multicast traffic is transmitted.

The controller may be configured to control the mobile station to perform a network entry procedure with the BS.

The controller may be configured to control the RF unit to receive from the BS an M2M group ID with respect to a service flow added through a dynamic service addition (DSA) procedure with the BS, wherein the added service flow corresponds to multicast traffic.

The controller may be configured to control the RF unit to receive a flow ID (FID) and a quality of service (QoS) parameter from the BS through the DSA procedure.

The controller may be configured to control the RF unit to receive an M2M group ID with respect to a service flow with respect to the multicast traffic from the BS through a capability negotiation procedure with the BS.

The controller may be configured to control the RF unit to receive a flow ID (FID) and a quality of service (QoS) parameter from the BS through the capability negotiation procedure.

The controller may be configured to control the RF unit to receive an M2M group ID with respect to a service flow with respect to multicast traffic from the BS through a registration procedure.

The controller may be configured to control the RF unit to receive a flow ID (FID) and a quality of service (QoS) parameter from the BS through a dynamic service addition (DSA) procedure.

The controller may be configured to control the RF unit to receive an M2M group ID with respect to a service flow with respect to the multicast traffic from the BS through a deregistration procedure with the BS.

The controller may be configured to control the RF unit to receive a flow ID (FID) and a quality of service (QoS) parameter from the BS through the deregistration procedure.

The paging message may indicate a multicast traffic reception without a network re-entry with the BS.

The control information may comprise an action code field.

### Advantageous Effects of Invention

According to the present disclosure, power consumption of an M2M mobile station can be reduced and resources of an M2M system can be effectively used by transmitting traffic to every M2M mobile station belonging to a particular M2M group with respect to a particular service flow by using the multicast transmission method.

### BRIEF DESCRIPTION OF DRAWINGS

FIG. 1 is a view showing an example of a defined time interval allocated to an MTC mobile station having time-controlled traffic characteristics.

FIG. 2 is a conceptual view showing a wireless communication system to which an embodiment of the present disclosure can be applicable.

FIG. 3 is a flow chart illustrating a paging procedure in an idle mode.

FIG. 4 is a flow chart illustrating a method for receiving multicast traffic by an idle mode mobile station according to an embodiment of the present disclosure.

FIG. 5 is a flow chart illustrating a first embodiment of a method for assigning an M2M group ID according to an embodiment of the present disclosure.

FIG. 6 is a flow chart illustrating a second embodiment of a method for assigning an M2M group ID according to an embodiment of the present disclosure.

FIG. 7 is a flow chart illustrating a third embodiment of a method for assigning an M2M group ID according to an embodiment of the present disclosure.

FIG. 8 is a flow chart illustrating a first embodiment for a method of receiving allocation of an FID and a QoS parameter for a mobile station according to an embodiment of the present disclosure.

FIG. 9 is a flow chart illustrating a second embodiment for a method of receiving allocation of an FID and a QoS parameter for a mobile station according to an embodiment of the present disclosure.

FIG. 10 is a flow chart illustrating a third embodiment for a method of receiving allocation of an FID and a QoS parameter for a mobile station according to an embodiment of the present disclosure.

FIG. 11 is a flow chart illustrating a fourth embodiment for a method of receiving allocation of an FID and a QoS parameter for a mobile station according to an embodiment of the present disclosure.

FIG. 12 is a flow chart illustrating a method for receiving multicast traffic by an idle mode mobile station according to another embodiment of the present invention.

FIG. 13 is a flow chart illustrating a method for receiving multicast traffic by an idle mode mobile station according to another embodiment of the present invention.

FIG. 14 is an internal block diagram of a mobile station and a BS in a wireless access system to which an embodiment of the present disclosure can be applicable.

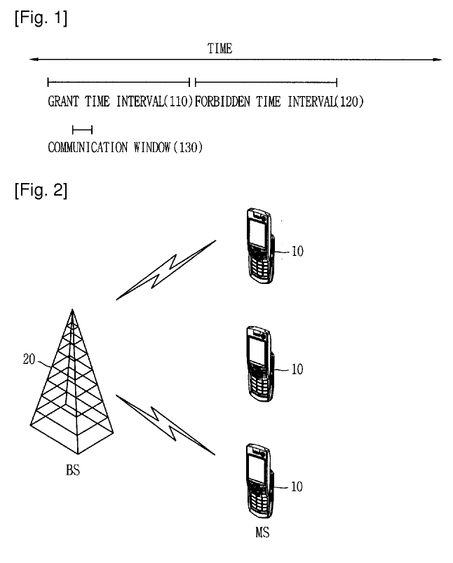

### BEST MODE FOR CARRYING OUT THE INVENTION

The following technique may be used for various wireless communication systems such as CDMA (code division multiple access), FDMA (frequency division multiple access), TDMA (time division multiple access), OFDMA (orthogonal frequency division multiple access), SC-FDMA (single carrier-frequency division multiple access), and the like. CDMA may be implemented as a radio technology such as UTRA (Universal Terrestrial Radio Access) or CDMA2000. TDMA may be implemented as a radio technology such as GSM (Global System for Mobile communications)/GPRS (General Packet Radio Service)/EDGE (Enhanced Data Rates for GSM Evolution). OFDMA may be implemented as a radio technology such as IEEE 802.11 (Wi-Fi), IEEE 802.16 (WiMAX), IEEE 802-20, E-UTRA (Evolved UTRA), and the like. IEEE 802.16m is an advancement of IEEE 802.16e, providing backward compatibility with an IEEE 802.16e-based system.

Also, 802.16p provides a communication standard for supporting machine type communication (MTC).

UTRA is a part of UMTS (Universal Mobile Telecommunications System). 3GPP (3rd Generation Partnership Project) LTE (long term evolution) is part of E-UMTS (Evolved UMTS) using E-UTRA, which employs OFDMA in downlink and SC-FDMA in uplink. LTE-A (Advanced) is an advancement of 3GPP LTE.

The terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

The exemplary embodiments of the present invention will now be described with reference to the accompanying drawings, in which like numbers refer to like elements throughout. In describing the present invention, if a detailed explanation for a related known function or construction is considered to unnecessarily divert the gist of the present invention, such explanation has been omitted but would be understood by those skilled in the art. The accompanying drawings of the present invention aim to facilitate understanding of the present invention and should not be construed as limited to the accompanying drawings. The technical idea of the present invention should be interpreted to embrace all such alterations, modifications, and variations in addition to the accompanying drawings.

FIG. 2 is a conceptual view of a wireless communication system to which an embodiment of the present disclosure can be applicable. The wireless communication system is widely disposed to provide various communication services such as voice, packet data, or the like.

With reference to FIG. 2, the wireless communication system may include a mobile station (MS) 10 and a base station (BS) 20. The MS may be fixed or mobile and may be called by other names such as UE (User Equipment), UT (User Terminal), SS (Subscriber Station), wireless device, AMS (Advanced Mobile Station), or the like. Also, the MS 10 may have a concept of MTC or M2M mobile station.

The BS 20 generally refers to a fixed station communicating with the MS 10, and may be called by other names such as NodeB, BTS (Base Transceiver System), access point. One or more cells may exist in the single BS 20.

The wireless communication system may be an OFDM (Orthogonal Frequency Division Multiplexing)/OFDMA (Orthogonal Frequency Division Multiple Access)-based system.

OFDM uses multiple orthogonal subcarriers. OFDM uses orthogonal characteristics between IFFT (inverse fast Fourier Transform) and FFT (fast Fourier Transform). A transmitter performs IFFT on data and transmits the same. A receiver performs FFT on received signal to restore the original data. The transmitter uses IFFT in order to couple multiple subcarriers, and the receiver uses corresponding FFT in order to separate multiple subcarriers.

Paging in Idle Mode

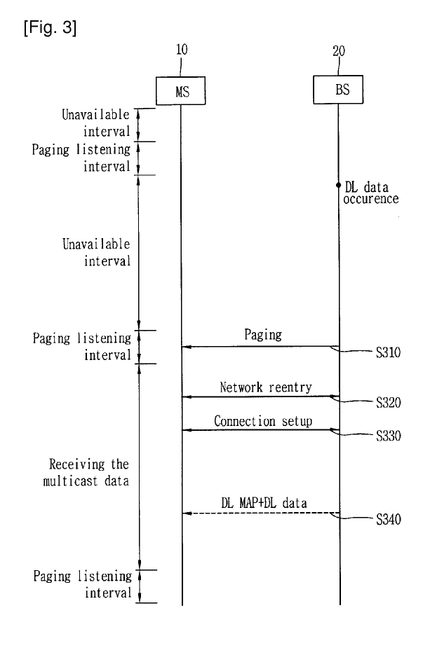

FIG. 3 is a view showing a paging procedure in an idle mode.

The following description is based on IEEE 802.16e, 16m, 16p systems for the sake of brevity. However, a technical concept of the present invention is not limited thereto.

With reference to FIG. 3, in order for a mobile station (MS) to enter an idle mode, the mobile station (MS) transmits a deregistration request (DREG-REQ) message to a base station (BS) to request deregistration with the BS.

Then, in response to the DREG-REQ message, the BS transmits a deregistration response (DREG-RSP) message to the MS. Here, the DREG-RSP message includes paging information.

Here, MS's entering the idle mode may also be initiated by a request from the BS. In this case, the BS transmits the DREG-RSP message to the MS.

The paging information may include a paging cycle, a paging offset, a paging group identifier (PGID), a paging listening interval value, and the like.

When the MS receives the DREG-RSP, it enters an idle mode with reference to the paging information.

The idle mode has paging cycles, and one paging cycle may include an available interval and an unavailable interval. Here, the available interval is the same concept as a paging listening interval or a paging interval. The paging offset indicates a point in time (e.g., a frame or a subframe) at which a paging interval starts in a paging cycle. The paging group identifier (PGID) is an identifier (ID) of a paging group assigned to an MS.

The paging information may include paging message offset information. Here, the paging message offset information indicates a point in time at which a paging message is transmitted from the BS.

Thereafter, the MS may receive a paging message transmitted to the MS itself during the AI (namely, the paging listening interval) by using the paging information. Here, the paging message may be transmitted through the BS or a paging controller. Namely, the MS monitors a wireless channel according to a paging cycle in order to receive the paging message.

The MS in the idle mode receives a paging message during its paging listening interval to check whether or not there is downlink (DL) data transferred to the MS (S310). When there is downlink data (i.e., positive indication), the MS performs a network reentry procedure including a ranging procedure (S320). Thereafter, the MS performs a process of establishing a connection with respect to a relevant downlink service flow through a dynamic service addition (DSA) procedure (S330). After the connection with respect to the service flow is established, the BS transmits downlink data with respect to a corresponding service to the MS (S340).

Hereinafter, a method for an idle mode mobile station, in particular, an M2M mobile station in an idle mode, to receive multicast traffic without network reentry (or without idle mode termination) will be described in detail.

In the following description, for the sake of brevity, an M2M mobile station will be taken as an example, but a technical concept of the present disclosure is not limited thereto.

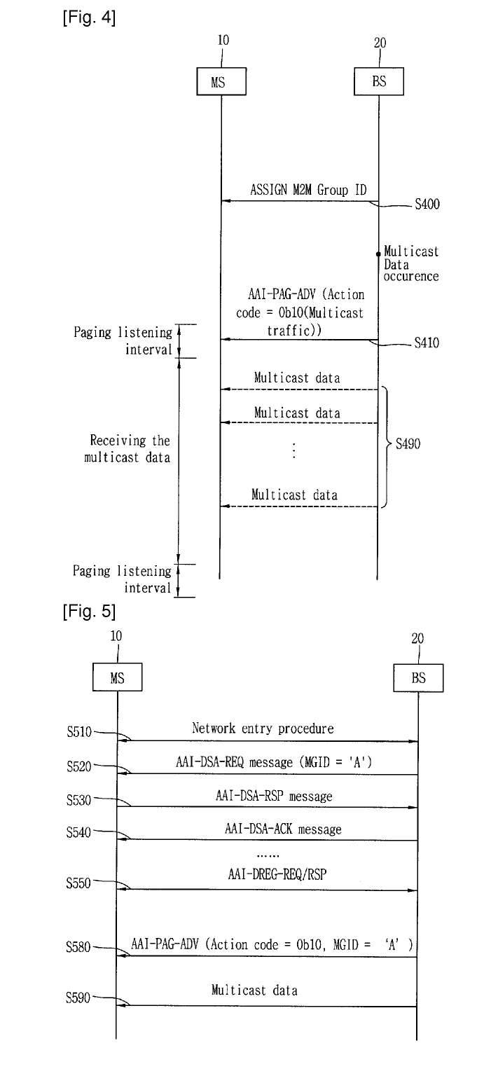

FIG. 4 is a flow chart illustrating a method for receiving multicast traffic by an idle mode M2M mobile station according to an embodiment of the present disclosure.

With reference to FIG. 4, the M2M mobile station 10 in an idle mode receives a paging (advertisement) message including control information in relation to multicast traffic transmission from the BS 20 during a paging listening interval (S410).

Here, the control information may be an action code indicating reception of multicast traffic or multicast traffic indication information indicating whether or not multicast traffic is transmitted.

Here, when the control information indicates a multicast traffic reception operation of the M2M mobile station (e.g., when action code is ‘0b10’) or indicates that multicast traffic is transmitted (e.g., when multicast traffic indication is set to ‘1’), the control information may refer to information indicating that the M2M mobile station in the idle mode receives multicast traffic in the idle mode without performing a network re-entry procedure.

Also, the control information may be transmitted through a particular downlink control channel (e.g., DL MAP IEs in a 16e system, A-MAP IE in a 16m system) or a particular MAC control message, as well as through a paging message (e.g., MOB_PAG-ADV in a 802.16e system, AAI-PAG-ADV or PGID-Info in a 802.16m system). In the present disclosure, for the sake of brevity, a case in which the control information is transmitted through a paging message AAI-PAG-ADV or MOB_PAG-ADV will be described as an example.

For an accurate transmission of multicast traffic, the control information, i.e., control information indicating that the multicast traffic should be received in an idle mode, as well as information indicating which mobile stations should receive the multicast traffic, must be transmitted. To this end, an M2M group and ‘identification information’ are defined.

The M2M group is a group of M2M mobile stations (or devices) that share one or more features in common. For example, the M2M group may be an aggregate of mobile stations providing a particular application service. Each M2M group receives allocation of an M2M group identifier (MGID) (S400), and the MGID uniquely identify an M2M group in the domain of the network entity that assigns MGID. Here, the network entity may be, for example, a BS.

The M2M group identifier (MGID) is assigned by the network entity, and in this case, the M2M group identifier (MGID) may be assigned to a service flow of an M2M mobile station after the initial network entry through a DSA procedure. Or, the M2M group identifier may be assigned through a different procedure. The process of allocating (assigning) the M2M group identifier will be described later in detail with reference to FIGS. 5 to 7. The assigned MGID is retained by the M2M mobile station unless the mobile station exit from the network or the network deletes the service flow associated with the MGID. The MGID may be changed through a dynamic service change (DSC) procedure.

The ‘identification information’ is an identifier indicating the M2M group which is to receive multicast and it may be, for example, the M2M group identifier (MGID). Here, the M2M group identifier may be expressed as a multicast group ID or a group ID.

In order to transmit multicast traffic according to an embodiment of the present invention, the paging message includes identification information indicating the mobile stations, i.e., the M2M group, which is to receive multicast traffic.

Thereafter, the M2M mobile station in the idle mode performs the following process based on the control information and the identification information received through the paging message.

First, when the control information indicates reception of multicast traffic (without network reentry), the M2M mobile station 10 in the idle mode checks whether or not the M2M group identifier assigned by the BS 20 (through the DSA) and the identification information received through the paging message are the same.

Upon checking, when the M2M group identifier assigned by the BS 20 and the identification information received through the paging message are the same, the M2M mobile station 10 in the idle mode receives downlink multicast traffic from the BS 20 without terminating the idle mode (S490). Here, the M2M mobile station 10 in the idle mode continuously decodes a downlink channel until a next paging listening interval in order to receive the downlink multicast traffic from the BS 20.

Table 1 below shows an example of a paging message format according to an embodiment of the present disclosure.

TABLE 1

| | | | |
|---|---|---|---|
| Fields | Size | Value | Condition |

| | | |
|---|---|---|
| For (i=0; | | Num_MGID indicates the |
| i<Num_MGID; i++) | | number of MGIDs included |
| { | | in this paging message |
| | | [0 . . . 63] |
| MGID | 12 | M2M Group ID |
| Action Code | 2 | 0b00: Performing network |
| | | reentry0b01: Performing |
| | | location update0b10: |
| | | Receiving multicast |
| | | traffic0b11: reserved |
| } | | |

Here, the control information may refer to ‘Action Code’ field of Table 1, and the identification information may refer to the ‘MGID’ field in Table 1.

With reference to Table 1, the ‘MGID’ field indicates an identifier of an M2M group to which multicast traffic is transmitted, and the MGID field may include one or more MGIDs.

Also, ‘Action Code’ field is information indicating an operation of a mobile station in an idle mode by the BS. For example, when Action Code is set to ‘0b10’, it indicates a multicast traffic reception operation of an idle mode M2M mobile station. Here, the indication (Action code=0b10) may refer to multicast traffic reception without network re-entry.

Table 2 below shows another example of a paging message format according to an embodiment of the present invention.

TABLE 2

| | | | |
|---|---|---|---|
| Fields | Size | Value | Condition |

| | | |
|---|---|---|
| Multicast traffic | 1 | Indicates whether multicast traffic is |
| Indication | | transmitted0: Multicast traffic is not |
| | | transmitted1: Multicast traffic is |
| | | transmitted |
| If (multicast traffic | | |
| indication == | | |
| 0b10) { | | |
| Group ID bitmap | 1 | Indicates whether Group ID has index |
| Indicator | | form or bitmap form 0: Index form1: |
| | | bitmap form |
| If (Group ID | | |
| bitmap Indicator = | | |
| 1) { | | |
| GroupID Group | TBD | It indicates the existence of each GroupID |
| Indication bitmap | (Default: | group. N-th bit of GroupID-Group In- |
| | 32) | dication Bitmap [MSB corresponds to N = |
| | | 0] is allocated to GroupID Group that |
| | | includes AMS with GroupID values from |
| | | N × 32 to N × 32 + 31 0: There is no traffic for |
| | | any of the 32 M2M devices that belong to |
| | | the GroupID-Group 1: There is traffic for |
| | | at least one M2M devices in GroupID- |
| | | Group. |
| Multicast Traffic | TBD | It indicates the traffic indication for 32 |
| Indication Bitmap | (Default: | M2M devices in each GroupID group Each |
| | N × 32) | Multicast Traffic Indication bitmap com- |
| | | prises multiples of 32-bit long Traffic In- |
| | | dication units. A Traffic Indication unit for |
| | | 32 GroupIDs is added to AAI-PAG-IND |
| | | message whenever its GoupID Group is set |
| | | to 1 32-bits of Traffic Indication Unit |
| | | (starting from MSB) are allocated to M2M |
| | | devices in the ascending order of their |
| | | GroupID values: 0: Negative indication 1: |
| | | Positive indication N = The number of ‘1’ in |
| | | GroupID Group Indication Bitmap (i.e. the |
| | | number of GroupID Group which has |
| | | positive traffic indication) |
| } else { | | |
| Num_of_GroupIDs | 6 | It indicates the number of GroupIDs |
| | | included in AAI_PAG-ADV message 0~63 |
| For(i=0; | | |
| i<Num_of_GroupI | | |
| Ds; | | |
| i++) { | | |
| GroupIDs | TBD(12) | Each GroupID is used to indicate the |
| | | positive multicast traffic indication for an |
| | | M2M device0~4095 |
| } // for | | |
| } | | |
| } | | |

Here, the control information may refer to a ‘multicast traffic indication’ field of Table 2, and the identification information may refer to ‘GroupIDs’ field in Table 2.

With reference to Table 2, ‘multicast traffic indication’ field indicates whether or not multicast traffic is transmitted. For example, when multicast traffic indication is set to 0, it indicates that multicast traffic is not transmitted, and when multicast traffic indication is set to 1, it indicates that multicast traffic is transmitted.

‘Group ID bitmap Indicator’ field indicates whether an identifier of an M2M group to which multicast traffic is to be transmitted has an index form or a bitmap form. For example, when ‘Group ID bitmap Indicator’ is set to 0, the M2M group identifier has an index form, and when ‘Group ID bitmap Indicator’ is set to 1, the M2M group identifier has a bitmap form. Here, the ‘Group ID bitmap Indicator’ field is included in a paging message when the ‘multicast traffic indication’ indicates that multicast traffic is transmitted.

Table 3 and Table 4 below show an example of a paging message format for applying a multicast receiving method proposed in the present disclosure to an IEEE 802.16e system.

TABLE 3

| Name | Type | Length | Value | Scope |
|---|---|---|---|---|
| M2M_Group_Paging | x | Vari- | Compound TLV | MOB_PAG- |
| parameters | | able | to be used in | ADV |
| | | | M2M group | |
| | | | paging operation | |

An M2M group paging parameter TLV value in Table 3 may be included in MOB_PAG-ADV message.

TABLE 4

| Name | Type | Length | Value |
|---|---|---|---|
| MGID | x.1 | 2 | Bit #0~Bit#14: Indicates M2M Group ID; |
| | | | Bit #15: Padding, Will be set to 0 |
| Action | x.2 | 1 | Bit #0~Bit#1: Indicates Action code for the |
| Code | | | M2M Group ID0b00 - Performing network |
| | | | reentry 0b01 - Performing location |
| | | | update0b10 - Receiving multicast traffic |
| | | | 0b11 - ReservedBit #2~Bit#7: Padding, Will |
| | | | be set to 0 |

TLV value in Table 4 will appear in each M2M group paging parameter TLV value.

An method of M2M group ID assignment will be described.

Hereinafter, for the sake of brevity, an IEEE 802.16m system will be described as an example. However, the technical concept of the present invention is not limited thereto.

FIG. 5 is a flow chart illustrating a first embodiment of a method for assigning an M2M group ID according to an embodiment of the present disclosure.

The M2M mobile station 10 performs a network entry procedure with the BS 20 (S510). Thereafter, the M2M mobile station 10 performs a dynamic service addition (DSA) procedure with the BS 20. Namely, the BS 20 transmits an AAI-DSA-REQ message to the M2M mobile station 10 (S520), the M2M mobile station 10 transmits AAI-DSA-RSP message to the BS 20 (S530), and the BS 20 transmits an AAI-DSA-ACK message to the M2M mobile station 10 (S540), thereby performing the DSA procedure. Here, the M2M mobile station 10 receives allocation of an M2M group identifier, i.e., MGID, with respect to a service flow associated with multicast traffic through the AAI-DSA-REQ message. In FIG. 5, it is illustrated that the M2M mobile station 10 receives allocation of ‘A’ as an M2M group ID. Here, the M2M group ID may be expressed as a multicast group ID or a group ID.

Thereafter, the M2M mobile station 10 enters an idle mode. In order to enter the idle mode, the M2M mobile station 10 may transmit and receive the AAI-DREG-REQ message and the AAI-DREG-RSP message to and from the BS 20 (S550).

The M2M mobile station in the idle mode receives a paging (advertisement) message including control information related to multicast traffic transmission from the BS 20 during a paging listening interval (S580). Here, when the control information indicates reception of multicast traffic (Action code=0b10) (without network reentry), the M2M mobile station 10 in the idle mode checks whether or not the M2M group ID (A) assigned from the BS 20 and the identification information received through the paging message are identical.

Upon checking, when the M2M group ID (A) assigned from the BS 20 and the identification information received through the paging message are identical, the M2M mobile station 10 in the idle mode receives downlink multicast traffic from the BS 20 without terminating the idle mode (S590).

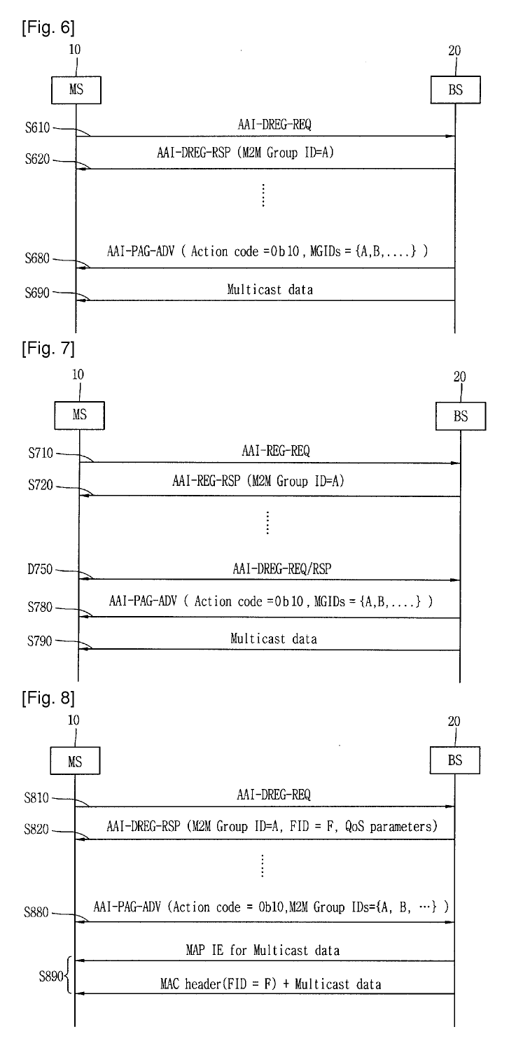

FIG. 6 is a flow chart illustrating a second embodiment of a method for assigning an M2M group ID according to an embodiment of the present disclosure.

The M2M mobile station 10 may receive allocation of an M2M group identifier when entering an idle mode.

For example, the M2M mobile station 10 enters an idle mode through a deregistration procedure with the BS 20, and at this time, the M2M mobile station 20 can receive allocation of an M2M group ID. Namely, the M2M mobile station 10 transmits an AAI-DREG-REQ message to the BS 20 to request deregistration (S610). Upon receiving the AAI-DREG-REQ message, the BS 20 transmits an AAI-DREG-RSP message to acknowledge deregistration (S620). Here, the BS 20 may assign an M2M group identifier to the M2M mobile station 10. In FIG. 6, it is illustrated that the M2M mobile station 10 receives allocation of ‘A’ as an M2M group identifier. In this case, the M2M group identifier may be expressed as a multicast group ID or a group ID.

Thereafter, the M2M mobile station 10 enters an idle mode. The M2M mobile station in the idle mode receives a paging (advertisement) message including control information related to multicast traffic transmission from the BS 20 during a paging listening interval (S680). Here, when the control information indicates reception of multicast traffic (Action code=0b10) (without network reentry), the M2M mobile station 10 in the idle mode checks whether or not the M2M group ID (A) assigned from the BS 20 and the identification information received through the paging message are identical.

Upon checking, when the M2M group ID (A) assigned from the BS 20 and the identification information received through the paging message are identical, the M2M mobile station 10 in the idle mode receives downlink multicast traffic from the BS 20 without terminating the idle mode (S690).

FIG. 7 is a flow chart illustrating a third embodiment of a method for assigning an M2M group ID according to an embodiment of the present disclosure.

The M2M mobile station 10 may receive allocation of an M2M group ID through a capability negotiation procedure during an initial network entry.

For example, the M2M mobile station 10 may transmit an AAI-REG-REQ message to the BS 20 to request the capability negotiation (S710). Upon receiving the AAI-REG-REQ message, the BS 20 performs a relevant capability negotiation and transmits an AAI-REG-RSP message (S720). In this case, the BS 20 may assign an M2M group ID to the M2M mobile station 10. In FIG. 7, it is illustrated that the M2M mobile station 10 receives allocation of ‘A’ as an M2M group ID. Here, the M2M group ID may be expressed as a multicast group ID or a group ID.

Thereafter, the M2M mobile station 10 enters an idle mode. In order to enter the idle mode, the M2M mobile station 10 may transmit and receive the AAI-DREG-REQ message and the AAI-DREG-RSP message to and from the BS 20 (S750).

The M2M mobile station in the idle mode receives a paging (advertisement) message including control information related to multicast traffic transmission from the BS 20 during a paging listening interval (S780). Here, when the control information indicates reception of multicast traffic (Action code=0b10) (without network reentry), the M2M mobile station 10 in the idle mode checks whether or not the M2M group ID (A) assigned from the BS 20 and the identification information received through the paging message are identical.

Upon checking, when the M2M group ID (A) assigned from the BS 20 and the identification information received through the paging message are identical, the M2M mobile station 10 in the idle mode receives downlink multicast traffic from the BS 20 without terminating the idle mode (S790).

In another example, the capability negotiation procedure may be performed by using an AAI-SBC-REQ/RSP message instead of the AAI-REG-REQ/RSP message.

Also, the mobile station may receive allocation of the M2M group ID through a MAC message after entering the network. For example, the mobile station may transmit a group ID allocation request MAC message and receive a group ID allocation response message from the BS, whereby the mobile station can receive allocation of an M2M group ID.

Hereinafter, a method for receiving allocation of a flow identifier (FID) and quality of service (QoS) will be described.

FIG. 8 is a flow chart illustrating a first embodiment for a method of receiving allocation of an FID and a QoS parameter for a mobile station according to an embodiment of the present disclosure.

As described above, in order for the M2M mobile station to receive multicast data without a network reentry in the idle mode, the M2M mobile station may receive allocation of a flow ID (FID) and a QoS parameter, as well as the M2M group ID. The assigned FID is included in a MAC header when the BS 20 transmits multicast data.

The M2M mobile station 10 may receive allocation of an FID and a QoS parameter when entering the idle mode.

For example, in the IEEE 802.16 system, the M2M mobile station 10 may enter the idle mode through a deregistration procedure with the BS 20, and at this time, the M2M mobile station 10 may receive allocation of an FID and a QoS parameter. Namely, the M2M mobile station may request deregistration by transmitting an AAI-DREG-REQ message to the BS 20 (S810). Upon receiving the AAI-DREG-REQ message, the BS 20 transmits an AAI-DREG-RSP message to acknowledge deregistration (S820). At this time, the BS 20 may transmit the FID and the QoS parameter for receiving multicast traffic to the M2M mobile station 10 through an AAI-DREG-RSP message. In FIG. 8, it is illustrated that the M2M mobile station 10 receives allocation of ‘A’ as an M2M group identifier and ‘F’ as an FID. In this case, the M2M group identifier may be expressed as a multicast group ID or a group ID.

Thereafter, the M2M mobile station 10 enters an idle mode. The M2M mobile station in the idle mode receives a paging (advertisement) message including control information related to multicast traffic transmission from the BS 20 during a paging listening interval (S880). Here, when the control information indicates reception of multicast traffic (Action code=0b10) (without network reentry), the M2M mobile station 10 in the idle mode checks whether or not the M2M group ID (A) assigned from the BS 20 and the identification information received through the paging message are identical.

Upon checking, when the M2M group ID (A) assigned from the BS 20 and the identification information received through the paging message are identical, the M2M mobile station 10 in the idle mode receives downlink multicast traffic from the BS 20 without terminating the idle mode (S890). When the multicast traffic is transmitted, a corresponding MAP information element (IE) is transmitted, and the FID is included in a MAC header of the multicast traffic.

FIG. 9 is a flow chart illustrating a second embodiment for a method of receiving allocation of an FID and a QoS parameter for a mobile station according to an embodiment of the present disclosure.

The M2M mobile station 10 may receive allocation of an FID and a QoS parameter through a capability negotiation procedure during an initial network entry.

For example, the M2M mobile station 10 may transmit an AAI-REG-REQ message to the BS 20 to request the capability negotiation (S910). Upon receiving the AAI-REG-REQ message, the BS 20 transmits an AAI-REG-RSP message to an M2M server 30, for a relevant capability negotiation (S913). The M2M server 30 performs a relevant capability negotiation and transmits an M2M group ID to be assigned to the mobile station to the BS 20 through an AAI-REG-RSP message (S916). The BS 20 transmits the AAI-REG-RSP message to the M2M mobile station 10 (S920). In this case, the BS 20 may transmit an M2M group ID, an FID, and a QoS parameter to the M2M mobile station 10 through the AAI-REG-RSP message. In FIG. 9, it is illustrated that the M2M mobile station 10 receives allocation of ‘A’ as an M2M group identifier and ‘F’ as an FID. In this case, the M2M group identifier may be expressed as a multicast group ID or a group ID.

In another example, the capability negotiation procedure may be performed by using an AAI-SBC-REQ/RSP message, rather than the AAI-REG-REQ/RSP message.

Thereafter, the M2M mobile station 10 enters an idle mode. The M2M mobile station in the idle mode receives a paging (advertisement) message including control information related to multicast traffic transmission from the BS 20 during a paging listening interval (S980). Here, when the control information indicates reception of multicast traffic (Action code=0b10) (without network reentry), the M2M mobile station 10 in the idle mode checks whether or not the M2M group ID (A) assigned from the BS 20 and the identification information received through the paging message are identical.

Upon checking, when the M2M group ID (A) assigned from the BS 20 and the identification information received through the paging message are identical, the M2M mobile station 10 in the idle mode receives downlink multicast traffic from the BS 20 without terminating the idle mode (S990). When the multicast traffic is transmitted, a corresponding MAP information element (IE) is transmitted, and the FID is included in a MAC header of the multicast traffic.

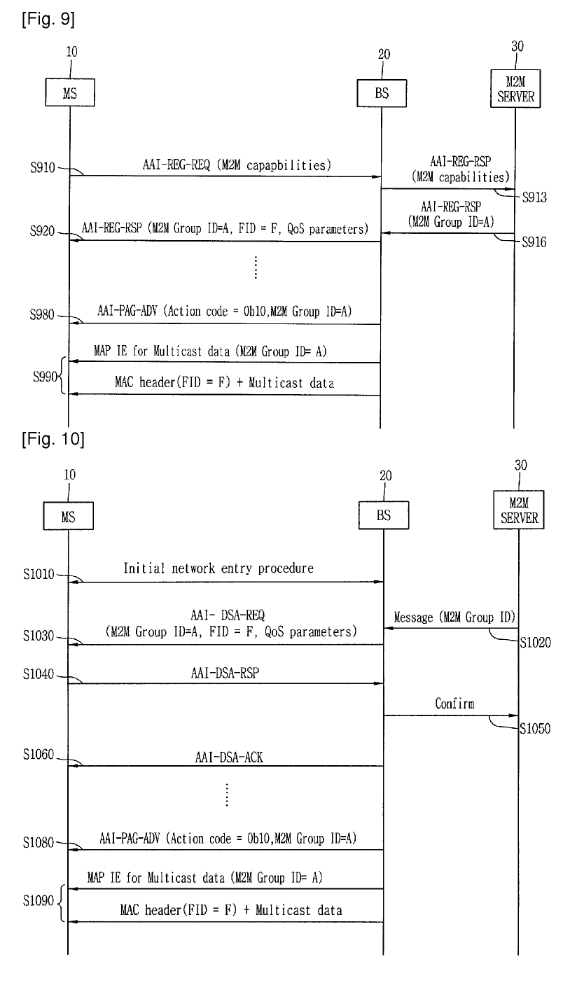

FIG. 10 is a flow chart illustrating a third embodiment for a method of receiving allocation of an FID and a QoS parameter for a mobile station according to an embodiment of the present disclosure.

After performing an initial network entry procedure, the M2M mobile station 10 may receive allocation of an FID and a QoS parameter through a dynamic service addition (DSA) procedure.

First, the M2M mobile station 10 performs an initial network entry procedure with the BS 20 (S1010). Thereafter, the BS 20 receives an M2M group ID with respect to the M2M mobile station 10 from the M2M server 30(S1020). And then, the BS 20 performs a DSA procedure with the M2M mobile station 10(S1030). In order to perform the DSA procedure, the BS 20 transmits an AAI-DSA-REQ message to the M2M mobile station 10 (S1030), and the M2M mobile station 10 transmits an AAI-DSA-RSP message to the BS 20 (S1040). In this case, the BS 20 may transmit the M2M group ID, an FID and a QoS parameter to the M2M mobile station 10 through the AAI-DSA-REQ message. Upon receiving a normal AAI-DSA-RSP message from the M2M mobile station 10, the BS 20 transmits acknowledgement (confirm) to the M2M server 30 (S1050) and transmits an AAI-DSA-ACK message to the mobile station (S1060). In FIG. 10, it is illustrated that the M2M mobile station 10 receives allocation of ‘A’ as an M2M group identifier and ‘F’ as an FID. In this case, the M2M group identifier may be expressed as a multicast group ID or a group ID.

Thereafter, the M2M mobile station 10 enters an idle mode. The M2M mobile station in the idle mode receives a paging (advertisement) message including control information related to multicast traffic transmission from the BS 20 during a paging listening interval (S 1080). Here, when the control information indicates reception of multicast traffic (Action code=0b10) (without network reentry), the M2M mobile station 10 in the idle mode checks whether or not the M2M group ID (A) assigned from the BS 20 and the identification information received through the paging message are identical.

Upon checking, when the M2M group ID (A) assigned from the BS 20 and the identification information received through the paging message are identical, the M2M mobile station 10 in the idle mode receives downlink multicast traffic from the BS 20 without terminating the idle mode (S 1090). When the multicast traffic is transmitted, a corresponding MAP information element (IE) is transmitted, and the FID is included in a MAC header of the multicast traffic.

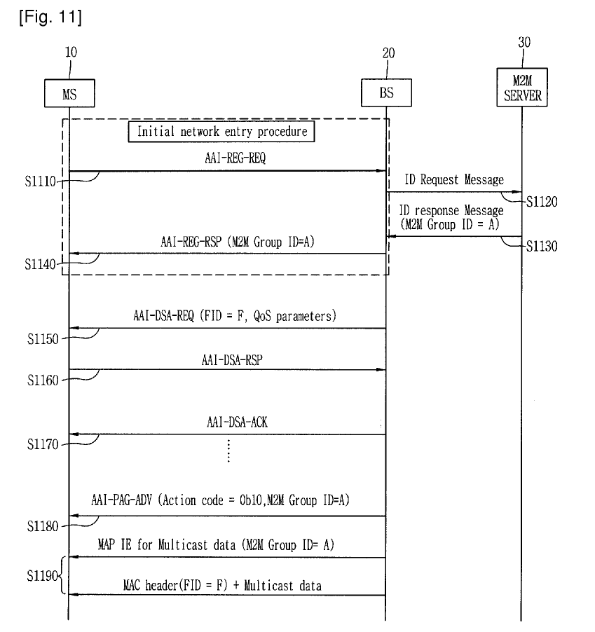

FIG. 11 is a flow chart illustrating a fourth embodiment for a method of receiving allocation of an FID and a QoS parameter for a mobile station according to an embodiment of the present disclosure.

The M2M mobile station 10 may receive allocation of an M2M group ID through a registration procedure in an initial network entry procedure, and an FID and a QoS parameter through a dynamic service addition (DSA) procedure after the initial network entry procedure.

First, the M2M mobile station 10 performs an initial network entry procedure with the BS 20. At this time, the M2M mobile station 10 transmits an AAI-REG-REQ message to the BS 20 (S1110). Upon receiving the AAI-REG-REQ message, the BS 20 requests an M2M group ID with respect to the M2M mobile station 10 to the M2M server 30 through an ID Request message (S1120). The M2M server 30 assigns an M2M group ID with respect to the M2M mobile station 10 and transmits the assigned M2M group ID to the BS 20 through an ID Response message (s1130). The BS 20 transmits the M2M group ID to the M2M mobile station 10 through an AAI-REG-RSP message (S1140).

Thereafter, the BS 20 performs a DSA procedure with the M2M mobile station 10. In order to perform the DSA procedure, the BS 20 transmits an AAI-DSA-REQ message to the M2M mobile station 10 (S1150), and the M2M mobile station 10 transmits an AAI-DSA-RSP message to the BS 20 (S1160). At this time, the BS may assign an FID and a QoS parameter to the M2M mobile station 10 through the AAI-DSA-REQ message. Upon receiving a normal AAI-DSA-RSP message from the M2M mobile station 10, the BS 20 transmits an AAI-DSA-ACK message to the mobile station (S 1170). In FIG. 11, it is illustrated that the M2M mobile station 10 receives allocation of ‘A’ as an M2M group identifier and ‘F’ as an FID. In this case, the M2M group identifier may be expressed as a multicast group ID or a group ID.

Thereafter, the M2M mobile station 10 enters an idle mode. The M2M mobile station in the idle mode receives a paging (advertisement) message including control information related to multicast traffic transmission from the BS 20 during a paging listening interval (S 1180). Here, when the control information indicates reception of multicast traffic (Action code=0b10) (without network reentry), the M2M mobile station 10 in the idle mode checks whether or not the M2M group ID (A) assigned from the BS 20 and the identification information received through the paging message are identical.

Upon checking, when the M2M group ID (A) assigned from the BS 20 and the identification information received through the paging message are identical, the M2M mobile station 10 in the idle mode receives downlink multicast traffic from the BS 20 without terminating the idle mode (S 1190). When the multicast traffic is transmitted, a corresponding MAP information element (IE) is transmitted, and the FID is included in a MAC header of the multicast traffic.

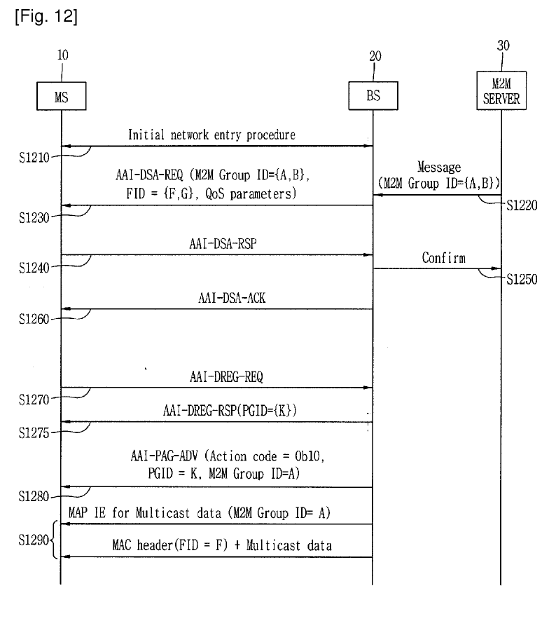

FIG. 12 is a flow chart illustrating a method for receiving multicast traffic by an idle mode mobile station according to another embodiment of the present invention.

When a BS performs group paging on mobile stations, the BS assigns a paging group ID (PGID) in a de-registration procedure, and separately assigns an ID (M2M group ID) related to transmission of multicast traffic. Namely, information of a paging group and M2M group information may be differently configured and differently used.

Steps S1210 to S1260 in FIG. 12 are the same as S1010 and S1060 in FIG. 10 as described above. In FIG. 12, it is illustrated that the M2M mobile station 10 receives allocation of ‘A, B’ as an M2M group identifier and ‘F, G’ as an FID. In this case, the M2M group identifier may be expressed as a multicast group ID or a group ID.

Thereafter, the M2M mobile station 10 enters an idle mode. In order to enter the idle mode, the M2M mobile station 10 may transmit an AAI-DREG-REQ message to the BS 20 (S1270). Upon receiving the AAI-DREG-REQ message, the BS 20 transmits an AAI-DREG-RSP message to acknowledge deregistration (S1275). Here, the BS 20 may assign an ID for multicast group paging (PGID) to the M2M mobile station 10 through the AAI-DREG-RSP message. In FIG. 12, it is illustrated that the M2M mobile station 10 receives allocation of ‘K’ as a PGID.

The M2M mobile station in the idle mode receives a paging (advertisement) message from the BS 20 during a paging listening interval (S1280). Upon checking the paging message, when the paging is group paging with respect to the paging group K, the mobile station checks which M2M group the paging is related. In FIG. 12, it is illustrated that a multicast transmission with respect to group A among groups A and B is indicated.

In addition, when the control information indicates reception of multicast traffic (Action code=0b10) (without network reentry), the M2M mobile station 10 in the idle mode checks whether or not the M2M group ID (A) assigned from the BS 20 and the identification information received through the paging message are identical. Upon checking, when the M2M group ID (A) assigned from the BS 20 and the identification information received through the paging message are identical, the M2M mobile station 10 in the idle mode receives downlink multicast traffic from the BS 20 without terminating the idle mode (S 1290). When the multicast traffic is transmitted, a corresponding MAP information element (IE) is transmitted, and the FID is included in a MAC header of the multicast traffic.

Group paging may be performed by M2M group basis. Namely, an ID of an M2M group to which a mobile station belongs is assigned in the initial network entry procedure, and a paging group is indicated by using the assigned M2M group ID in performing group paging.

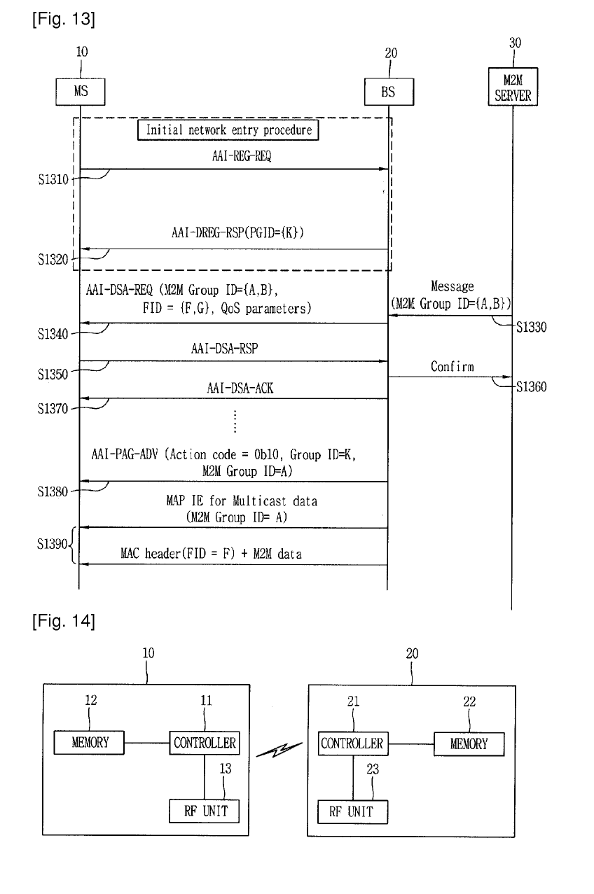

FIG. 13 is a flow chart illustrating a method for receiving multicast traffic by an idle mode mobile station according to another embodiment of the present invention.

The process of FIG. 13 is the same as that of FIG. 12, except that the M2M mobile station 10 receives allocation of an M2M group ID through a registration procedure in the initial network entry procedure, and receives allocation of an FID and a QoS parameter through a dynamic service addition (DSA) procedure after the initial network entry procedure.

FIG. 14 is an internal block diagram illustrating a mobile station and a base station in a wireless access system to which an embodiment of the present disclosure is applicable.

A mobile station 10 may include a controller 11, a memory 12, and a radio frequency (RF) unit 13.

Furthermore, the mobile station may also include a display unit, a user interface unit, and the like.

The controller 11 implements the proposed functions, processes and/or methods. The layers of the radio interface protocol may be implemented by the controller 11.

The memory 12, which is connected to the controller 11, may store protocols or parameters for performing wireless communication. In other words, the memory 12 may store mobile station driving systems, applications, and general files.

The RF unit 13, which is connected to the controller 11, may transmit and receive radio signals.

In addition, the display unit may display various types of information of the mobile station, and well-known elements such as a liquid crystal display (LCD), organic light emitting diodes (OLED), or the like may be used. The user interface unit may be implemented in combination of well-known user interfaces such as a keypad, a touch screen, or the like.

A base station 20 may include a controller 21, a memory 22, and a radio frequency (RF) unit 23.

The controller 21 implements the proposed functions, processes and/or methods. The layers of the radio interface protocol may be implemented by the controller 21.

The memory 22, which is connected to the controller 21, may store protocols or parameters for performing wireless communication.

The RF unit 23, which is connected to the controller 21, may transmit and receive radio signals.

The controllers 11 and 21 may include application-specific integrated circuits (ASICs), other chip sets, logic circuit and/or data processing devices, respectively. The memories 12 and 22 may include read-only memory (ROM), random access memory (RAM), flash memory, memory card, storage medium and/or other storage devices. The RF units 13 and 23 may include a baseband circuit for processing radio signals, respectively. When the embodiment is implemented by software, the foregoing technique may be implemented by a module (process, function, etc.) performing the foregoing function. The module may be stored in the memories 12 and 22, and implemented by the controllers 11 and 21.

The memories 12 and 22 may be located within or outside the controllers 11 and 21, respectively, and may be connected to the controllers 11 and 21 through well-known various means, respectively.

1. A method for receiving multicast traffic by a mobile station in an idle mode in a wireless access system supporting machine-to-machine (M2M) communication, the method comprising:
receiving a paging message from a base station (BS) during a paging listening interval; and
receiving the multicast traffic from the BS without idle mode termination based on the received paging message,
wherein the paging message further includes identification information indicating M2M devices to which the multicast traffic is transmitted and control information indicating a multicast traffic reception without network re-entry with the BS.

2. The method of claim 1, further comprising:
performing a network entry procedure with the BS.

3. The method of claim 1, further comprising:
performing, with the BS, a dynamic service addition (DSA) procedure to add a service flow with respect to the multicast traffic,
wherein an M2M group ID is assigned to the added service flow with respect to the multicast traffic through the DSA procedure.

4. The method of claim 3, wherein, through the DSA procedure, a flow ID (FID) and a quality of service (QoS) parameter are further assigned.

5. A method for transmitting multicast traffic to a mobile station in an idle mode in a wireless access system supporting machine-to-machine (M2M) communication, the method comprising:
transmitting a paging message during a paging listening interval of the mobile station; and
transmitting the multicast traffic to the mobile station in without idle mode termination based on the transmitted paging message,
wherein the paging message further includes identification information indicating M2M devices to which the multicast traffic is transmitted and control information indicating a multicast traffic reception without network re-entry with the BS.

6-11. (canceled)

12. The method of claim 1, wherein the control information comprises an action code field.

13. A mobile station for receiving multicast traffic in an idle mode of a wireless access system supporting machine-to-machine (M2M) communication, the mobile station comprising:
a radio frequency (RF) unit configured to transmit and receive RF signals; and
a controller connected to the RF unit,
wherein the controller is configured to control the RF unit to receive a paging message from a base station (BS) during a paging listening interval and to control the RF unit to receive the multicast traffic from the BS without idle mode termination based on the received paging message,
wherein the paging message further includes identification information indicating M2M devices to which the multicast traffic is transmitted and control information indicating a multicast traffic reception without network re-entry with the BS.

14. The mobile station of claim 13, wherein, the controller is configured to control the mobile station to perform a network entry procedure with the BS.

15. The mobile station of claim 13, wherein the controller is configured to control the RF unit to receive from the BS an M2M group ID with respect to a service flow added through a dynamic service addition (DSA) procedure with the BS, wherein the added service flow corresponds to multicast traffic.

16. The mobile station of claim 15, wherein the controller is configured to control the RF unit to receive a flow ID (FID) and a quality of service (QoS) parameter from the BS through the DSA procedure.

17. An apparatus for transmitting multicast traffic to a mobile station in an idle mode in a wireless access system supporting machine-to-machine (M2M) communication, the apparatus comprising:
a radio frequency (RF) unit configured to transmit and receive RF signals; and
a controller connected to the RF unit,
wherein the controller is configured to control the RF unit to transmit a paging message during a paging listening interval of the mobile station and to control the RF unit to transmit the multicast traffic to the mobile station in without idle mode termination based on the transmitted paging message,
wherein the paging message further includes identification information indicating M2M devices to which the multicast traffic is transmitted and control information indicating a multicast traffic reception without network re-entry with the BS.

18-23. (canceled)

24. The mobile station of claim 13, wherein the control information comprises an action code field.
